(19) United States
(12) Patent Application Publication
(10) Pub. No.: US 2023/0385745 A1
(43) Pub. Date: Nov. 30, 2023

(54) COMPUTER METHODS AND SOFTWARE FOR PROCESSING SAP ERP TASKS

(71) Applicants: Avraham Mishan, Tel-Aviv-Yafo (IL); Shai Sinai, Tel-Aviv-Yafo (IL)

(72) Inventors: Avraham Mishan, Tel-Aviv-Yafo (IL); Shai Sinai, Tel-Aviv-Yafo (IL)

(21) Appl. No.: 18/034,038

(22) PCT Filed: Oct. 28, 2020
(86) PCT No.: PCT/IB2020/060079

§ 371 Date: Apr. 26, 2023

(51) Int. Cl. G06Q 10/067

(52) U.S. Cl. CPC G06Q 10/067

(57) ABSTRACT

A method for presenting an enterprise resource planning (ERP) output, the method may include generating a first data model of a first format, wherein the generating comprises using first business logic defined by a first ERP software to retrieve business data; modifying the first data model to provide a modified data model, by using a second ERP software that differs from the first ERP software, wherein the modifying comprises applying at least one function on the first data model, the at least one function being selected out of multiple functions of the second ERP software, wherein a selecting is executed without a substantial programming effort; and presenting the ERP output, the ERP output comprises at least a part of the modified data model.

### BACKGROUND

An enterprise resource planning (ERP) system, such as an example SAP system available from the software corporation SAP® SE, incorporates various databases, servers, and computer-based systems to manage an organization or company's enterprise-level data management requirements. SAP® SE covers many internal and external aspects in areas such as assets, financing, sales, logistics, management of human resources among others.

Generally, SAP ERP system is based on a three-tier architecture consisting of Presentation layer which contains the (graphical) user interface (UI); Database layer where business data and various metadata of the ERP system is stored; and Application layer, a communicator between Presentation Layer and Database Layer, where application programs are executed. Within any enterprise, users access various types of data that reside in the ERP system using SAP standard reporting platforms. Typically, SAP ERP-system operates by running programs called SAP reports. The report retrieves data from a data source, manipulates it and displays it to the user in tabular format. SAP report is written in ABAP programming language and is executed from SAP GUI. In GUI the users define selections of the data, that is the amount of data to be processed, e.g., aggregated sales data during a given period or region, inventory of goods, list of employees, etc. In the result table, data records appear in rows with columns that contain various data attributes. For example, an HR report can contain a column for the last name of an employee, a column for the first name for each employee, column for employee number, columns for phone number, address, etc.,

SAP provides numerous standard built-in reports for common tasks of the enterprise. However, the enterprise often cannot use these built-in reports, since they are lacking needed enterprise-related information. For this, SAP provides its customers with Integrated Development Environment (IDE) where the customers can develop their own customized reports using ABAP code. SAP environment provides a special arrangement of servers (called landscape) to support local development. Ideally, in SAP environment, a three-system landscape exists: Development System, Quality Assurance System, and Production System. Reports are developed in the development system by different roles (processes consultants, programmers, etc.), The Production system is where the enterprise business end-users work (live-environment). Before transporting from Development System to Production System, tests are performed in the Quality Assurance System. Thus, a customized report must be developed in the Development System, tested in Quality Assurance before being transported to the Production System to run in a live-environment. The development lifecycle is time consuming and expensive. Another disadvantage is that a customized report can be developed by different developers. Each report, therefore, includes different code styling and thus the end result will look different. Generally speaking, customized reports' functionality can neither be shared nor re-used between reports. Another option for customization is to create a modification in the standard source code. This type of modification, sometimes referred to as “repair”, is not supported by SAP. For example, when SAP releases an update, or bug fixes for modified reports, these reports will not be automatically updated. Unless it brings the organization a sustain business advantage, repairs are highly inadvisable.

### SUMMARY

There may be provided a computerized method and a non-transitory computer readable medium that stores commands/code/software for retrieving data from data sources available in SAP systems, and to display the results to the users in enhanced tabular and/or graphical formats. It comprises the steps of retrieving data and metadata (collectively referred to as data model) from data sources available in SAP systems and from external sources; storing the retrieved data model in computer memory; a step which comprises a set of processing instructions over the data model which persists in computer memory, presenting the data to the user in tabular or graphical formats and distribute in digital media.

In the first aspect, the computer method introduces an abstraction layer for data model manipulation and provides authors of reports (SAP specialists) a range of visual tools for defining the processing instructions within the abstraction layer.

The range of processing instructions provided with the software can be broadly categorized into: (1) adding data attributes to the data model comprising a set of processing functionalities, and (2) controlling what and how the data records are presented to the user.

In the second aspect, the software provides the set of programs necessary to accomplish these steps. The set of programs comprises the engine that processes in real-time the processing instructions specified by authors.

In the third aspect, the computer method also embodies the option to present the data in tabular or graphical formats in presentation layer SAP-GUI and SAPUI5, and to distribute the results in a variety of file formats and media.

### BRIEF DESCRIPTION OF DRAWINGS

FIG. 1 is an example of a method;

FIG. 2 is an example of a process of creating a new application variant by specifying new processing instructions on the data model;

FIG. 3 is an example of an Add Column/Formula functionality, outlining the arguments required to be specified for logical expression operation;

FIG. 4 is an example of a data model;

FIG. 5 is an example of a display of a modified data model in tabular or graphical format;

FIG. 6 is an example of a method; and

FIG. 7 is an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

The methods, and processes described below may be implemented as a computer program executing on one or more computers. The computer program may further be stored on a computer readable medium. The computer readable medium may include instructions for performing the processes described below. “Software”, “application” or, “system” here may include a computer program or algorithm, which when executed by a computer, causes the computer to perform a method, process, or function.

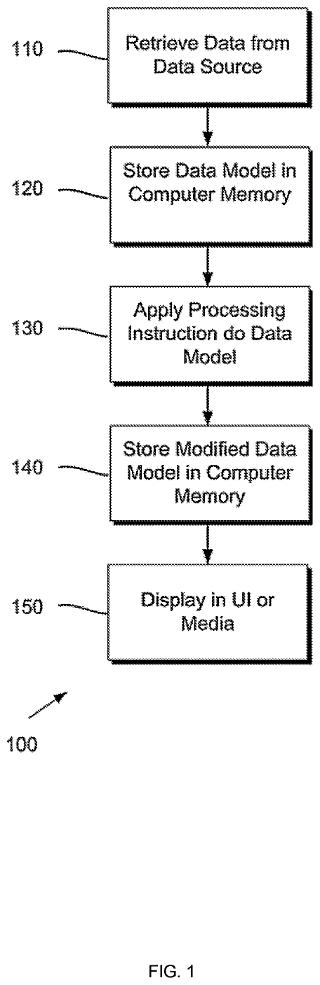

The computer method and software of present invention provides a method to retrieve data from data sources available in SAP systems, and to display the results to the users in enhanced tabular and/or graphical formats. As illustrated in FIG. 1, the transaction flow 100 of the system can envisaged as comprises the steps of retrieving data and metadata from data sources available in SAP systems 110; (here and further data and metadata are referred collectively as “data model”); storing the retrieved data model in computer memory 120; step which comprises set of processing instruction over the data model which persists in computer memory 130. This step is executed in runtime according to data processing instructions defined within the application as will be described below. The modified data model which results in the processing instruction is stored in computer memory 140. The final step the data model persisting in memory is presented to the user in tabular or graphical formats in graphical UI or media 150.

The specific instances of the steps outlined above are defined in “application variant”. The application variant points to “data selection variant”, or “selection variant” for short, which specifies the type and amount of data (number of records) to be retrieved from a data source (e.g., Purchase Orders for year 2019). The system is adapted to retrieve data model from a variety of data sources: SAP ALV report, DB Table, DB View, Core Data Services (CDS), or ODATA service. The application variant can be assigned a transaction code. As with other SAP transactions, execution of the process outlined in the application variant can be accomplished by entering transaction code in SAP UI.

The most frequently used data source for retrieving data model to the computer memory is via SAP ALV report. A standard SAP ALV report contains three main components: (1) Selection screen where the user can specify the extent of the data to be retrieved (e.g. aggregated sales for 2014); (2) Data processing component (sometimes referred to as “business logic” written in ABAP languages code; and (3) Presentation component where the result is displayed in ALV in SAP GUI or SAP WEBGUI. ALV stands for ABAP List Viewer. It is an output medium for displaying tabular data. ALV provides a standard list format and user interface to ABAP reports. ALV is created by a set of standard function modules provided by SAP. These components within the report are interlinked and cannot be accessed individually, in order to execute data model retrieval, the report must be called as one. Thus, in order to enhance such a report, a few alternatives exist. One alternative is to rewrite the business logic using ABAP code (named custom report) which requires significant programming efforts, and extensive development cycle through QA server to become ready to use in Production. A second disadvantage is that a custom report can be developed by separate developers. Each report therefore incorporates different code, and generally functionality cannot be re-used between reports developed by different authors. Another alternative is to modify existing SAP reports. This type of modification, sometimes referred to as “repair” is not supported by SAP and is highly inadvisable. For example, when SAP releases an update, or bug fixes, any modified object (including reports) will not be automatically updated.

In the present invention the SAP report is executed by so-called “dark call”. The dark call is the call of a report without using the SAP GUI. This means that neither selection screen nor result list is presented on a screen. The dark call is supported in ABAP language. In execution of a dark call all relevant checks are performed and in case of errors the call is aborted. When a data model is retrieved from other sources (e.g. DB Table) the retrieval process is accomplished directly without the use of a dark call.

The step of processing the data model that persists in computer memory is accomplished in runtime during transaction execution. This step is central to the methods of present invention. The invention provides authors (SAP specialists) with an integrated environment for creating customized processing instructions without any programming efforts by providing them with API (application programming interface) methods and application's built-in processing functions. The range of processing functionalities provided with the software can be broadly classified into several categories. It is convenient for the purpose of clarity of explanation to envision the data as presented in tabular format in terms of rows, which are different data records, and columns which are data attributes.

One category of processing functionalities is the addition of data attributes (columns) to a data model. Added columns may describe different kinds such as Formula (mathematical, string and other operations), Text (a column of text which describes data values found in another column), and DBLookup (values retrieved from other DB tables by the process of searching) to list a few. The addition of columns can be regarded as a generic functionality which results in a redesign of the data model by expanding it with additional data attributes. It must be supplemented with specific characteristics associated with the kind of attribute added. When the author invokes the “add column” functionality, it is necessary to specify what kind of data attribute is added; whether a Formula operation, Text or Dblookup, and other. Depending on the selected functionality other arguments need to be specified for proper execution of the functionality. For this, the application provides interactive screens in which the author specifies the arguments without reverting to include additional programming code.

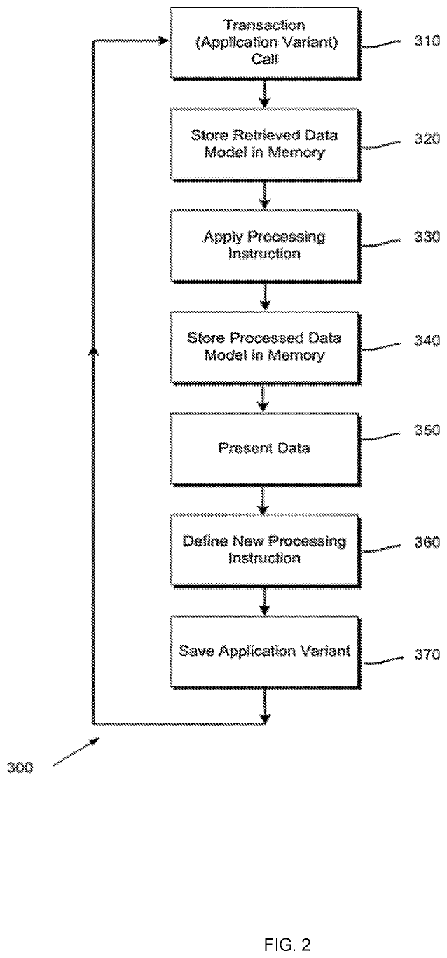

FIG. 2 illustrates the Add Column/Formula functionality 200. With the use of API, “Add Column” functionality is activated 210. The kind of the column (data attribute) “Formula Operation” is selected 220. For the mathematical operation to execute arguments the operands need to be specified 221 and the type of the mathematical operator 222. As an example, suppose that the added column contains multiplication of values found in another column. Here, it is necessary to specify the column that contains the values to be multiplied, the constant multiplicator, and the multiplication operator. Other specification 223 may be also required to Add Column functionality, column name, column position (e.g., referenced from another column id in the table). Once the functionality is defined, it is saved in the application variant 230.

When the software executes with the application variant, the results will display with the added column with the value corresponding to the mathematical operation. During runtime all checks will be performed and in case the values contained in the column to be multiplied are of a type that is non compatible with multiplication (i.e., non-numeric) the result will not be displayed and a corresponding log message will be issue.

In addition to numeric operation Formula Operation can also include non-numeric string operations, date/s time values conversion, and/or special functions or expressions and manipulations locally developed by the enterprise.

Another Add Column functionality comprises adding of text which describes data values found in another column. Such text can be retrieved from data which do not reside in the persisting data model. For example, an original Purchase Order report can include part numbers of a machinery, but it may be desirable to include textual description of these part numbers. The textual description of part numbers can be found in another table in a database where the part numbers (values) in one column are associated with the text located in another column. In case text column was defined per part numbers, during execution a column will be added to the data model next to the part numbers with the text retrieved from the part numbers description table. In the Add-Colum/Text it is unnecessary to specify the target column containing the values for the textual description (added column with retrieved text will appear adjacent to it) and text source.

Adding a column can also include retrieving a list of values that are a result of a search and retrieval of data available in the ERP database (Dblookup). Using Dblookup functionality returns a list of values from a specified column in a referenced data table. These values are compared against specified key values and only values in the database matching the key values are retrieved. The key values can be those persisting in the data model, constant values or values which are defined in the data model or reside in the system.

Another category of functionality provided in the present invention involves manipulation of data records (rows) is the Aggregating functionality. Aggregating becomes advantageous when the user wants to merge several rows (data records) to a single row according to a certain data attributes. For example, in one variant the records of sales for year 2019 are displayed in multiple rows, according to a date. A column in the table can contain the names of the salespersons, while another column can contain the total amount of the sale. The data records can be aggregated such that all records per salesperson are displayed in a single record, where the total amount for that salesperson will be summed and displayed in the corresponding field within the ‘amount” column. During the report creation, aggregating is achieved by defining the “aggregating functionality”. In specifying the aggregation functionality, one must indicate the attribute columns according to which aggregation of data is performed (key). Aggregation will be accomplished according to the values contained in the cells of the selected columns. With the aggregated instruction specified, a call for the transaction will execute the application variant and display aggregated results even when the transaction is defined with different data selections. In the example above, instead of selecting sales for 2019 a new data selection can include data for years 2017 to 2019. The result will display sales for years 2017-2019 aggregated per salespersons. However, one may still access to detailed data by via the aggregated records.

Continuing with the processing functionalities provided in the computer method of the current invention the Grouping functionality is clustering of data records. Contrary to the aggregating function, in grouping data records are not merged but assigned into hierarchical groups according to specified criteria. These criteria are values in specified attributes (columns) of the data. Data records that contain the set of criteria values are associated with a group, or multiplicity of groups based on these criteria values. For example, data records for purchasing orders can contain a column which contains the value of the vendor for the purchase, and a column listing the type of industry (business) area for describing the purchased item. Rows of data records can be grouped belonging to the same vendor, or alternatively grouped into clusters by industry area. Grouping can also be used for filtering data from being displayed. In the example here, only records belonging to a specific vendor can be chosen to be displayed.

Grouping of data records is achieved by indexing the data records (rows) according to the criteria values specified for grouping. The set of indices are stored in a table which is linked to data records. Data records with the same index appear adjacent to each other. When Filtering is applied the index table also contains a flag for suppressing the data from displaying.

Another functionality provided within the application is Conditional Formatting functionality, namely applying styling to specific data records or data attributes in data model matching specified criteria. Styling can include background color, or text color, or other highlighting options. The author of the report specifies a criteria value. The application evaluates the values in data attributes against this value. The application offers two options: when a value in attribute matches the specified criteria the application will (1) apply the selected styling format to all data records (rows) which contain the matching values in their attributes, or, (2) apply the styling to the column.

An important aspect of processing functionality provided in the disclosed invention is the ability to reference a specific data. Database that runs in Production environment is dynamic in nature; data is constantly updated. Therefore, rows enumerated by index as (e.g. row number from top of a table) in a table view do not generally correspond to the same specific data records. Data retrieved at a different instance, can appear in a different row number. Evidently, individual data records cannot be referenced by enumerating rows in a table. A unique and unambiguous correspondence is cannot be applied. Yet, it may be desirable for users to point to a specific data record or data records for follow up, adding comments, apply styling highlight, etc., To overcome this difficulty, in the present invention an internal key pointing to a specific data record is provided. A key to a data record is assigned based on values of its attribute. A data record comprises a set of attributes which defines. For example, in a table list of sales, different records can be distinguishable by a salesperson. Sales by the same salesperson are distinguishable by sale amount, customers, or date of the sale, etc., Assigning an identification key to a data record (or range of data records) is achieved by creating an internal table which juxtapositions values of their attributes. A table is stored in memory and linked to the transaction. Calling the transaction searches the internal table and creates a pointer to a specific data record. When the data records can be referenced, the users can define a number of operations which are related to specific data records. (1) Applying Styling, Coloring, or Highlighting. When the user specifies the Styling function the software assigns a key to the selected data records, the users choose from a list of Styles (Colors) to apply to those data records. For clarity of explanation, it is useful to use the following example which utilizes the ALV medium. One of the methods to display tabular data in the present invention is using the ALV medium. When applying styling, the users select a data record or multiple data records in ALV. The data rows appear in ALV with the selected style applied to cells corresponding to data records. This metadata attribute is saved in a database such that when the report is executed at a later time, the data record will appear with the new styling. (2) User Inputs. Another useful tool is providing an option of adding an input column kind where the users can type entries in a field corresponding to the data record. Such entries, or Inputs are usually typed content further describing the data record. When the user specifies Input in UI the software assigns a key to the data record, the typed Input and associated metadata is stored in the database. There is an option of adding a second column which displays the metadata associated with the Input, namely the data and time when the input has been added, the user, etc. (3) Comments. Another format of the inputs are Comments. Essentially, Comments are appended entries by several users displayed in chronological order.

A useful functionality of the present invention is the ability to add stand-alone business logic routines as Application Programming interface (API) available from application UI. Calling these routines requires specifying the data selection over which the API operates. All necessary checks are performed and if the data model does not match the data model for the API, the operation will abort. In SAP GUI this will appear as pushbuttons.

The computer method of the present invention provides for a layer of Authorization on top of the standard SAP authorization. SAP Authorization is a concept that protects transactions, programs, and services in SAP systems from unauthorized access. On the basis of the authorization concept, the administrator assigns authorizations to the users that determine the type of content the users may view and which actions a user can execute in the SAP System. In the context of an SAP report, authorization determines what extent of data records is available to the specific end-users. The computer method of the present invention provides for a layer of Authorization based on the standard SAP authorization in two aspects: (1) authorization at the data record level. The author or the authorization admin specifies authorization checks based on authorization-objects according to values defined in the data model, or/and system fields values or/and constant values. Given user authorization privileges, the data record will be displayed or restricted to the user. (2) Authorization at attributes (columns) level. Certain attributes can be marked as require authorization to display. For example, employees' salary can be displayed only to executives, HR or Finance officers within the enterprise who have the required authorization privileges. In case the end users do not have the authorization privileges, the data for this specific column will not be accessible, nor displayed for them.

SAP provides an option for automation of routine tasks and the optimization of the use of SAP computing resources by running Background processing. Background processes allocate memory differently than Foreground work processes. Background are non-interactive processes that run behind normal interactive operations. While foreground processes have preemption over computer resources, background processes have lower performance burden. One of the advantages of background processing is that it can be scheduled as per users' preferences (e.g. nighttime or other non-working hours), particularly when processing large amount of data of time and resources consuming intensive reports. It is possible using the software of present invention to execute a transaction background process. Transactions are executed results? of data retrieval are processed pursuant to processing instructions specified in Layout Variant, however instead of displaying data to the user the table is stored in the database table creating a “Snapshot” of the data model representing report. Working with Snapshots has several advantages. (1) Performance. Once a snapshot is created in a database it can be retrieved as a data model that persists in computer memory instead of executing SAP report, with the advantage that the snapshot stores already processed data so that no additional processing by business logic is required, and hence the data is retrieved very fast. With the data model persisting in memory the data model can be further displayed in ALV. (2) Archive. Snapshot can become useful if the user wants to revisit previous reports and compare them to current data. (3) Data source. Snapshot can be used as a data source in transaction (Applications Variants) of present invention using Snapshot vlookup function, that is, looking for and retrieving data in the snapshot table data range, matching certain associated values in ALV view. Once data is retrieved it can be processed according to all processing functionalities described above. For example, it can become particularly useful to display updated results, or how certain data progresses over time. The process would be retrieving older data records that correspond to snapshots created earlier.

The present invention also provides for a method of distributing of data model by digital media. At the first stage, the data model is converted to a selected data format and at the second stage it is published via selected media. Distribution can be performed in a push, that is, the content is sent to recipients from time to time or, pulled by SAP user via an email request. The software supports converting data model to HTML format, PDF format, Microsoft or Unix Excel formats (XLS, XLSX), delimited-value text formats to list a few. This can be distributed by e-mails, FTP, SMS, and mobile messenger applications.

While often data is presented in tabular format, graphical formats assist user users to visualize comparative values and to see trends in the data. The present invention provides for a method for displaying the user charts using a special container. A chart requires the associated column to be displayed in the data model. Different chart types (PIE, BARs etc.) can be selected from the drop-down menu provided in the system's UI. Charts can be displayed with data labeling options and legend options.

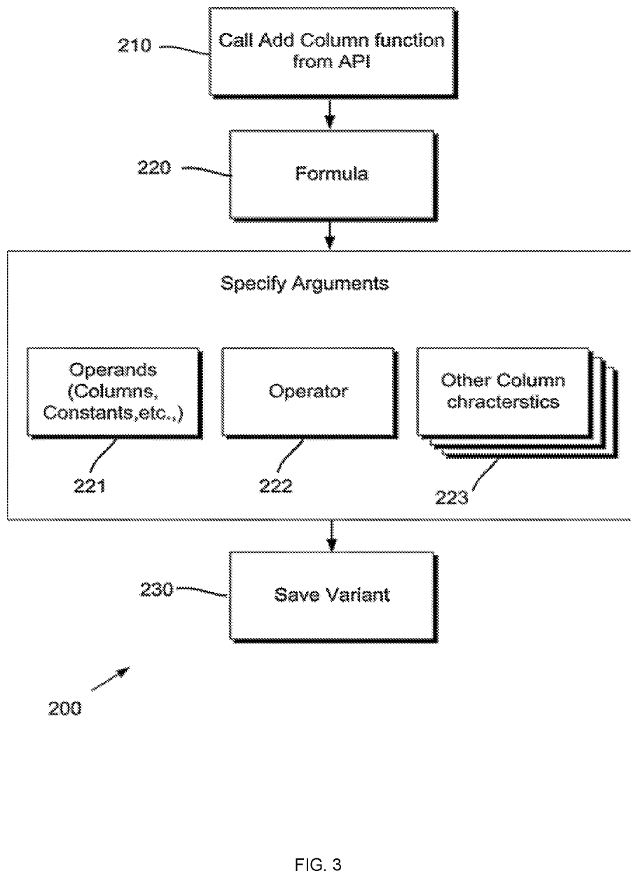

When a transaction of the application executes, processing the data model results in creation of a new data model. The new data model is stored and persists in memory and can be referenced for further processing. Additional processing can now be added on top of the new data model. Continuing with the aggregation example above, once the aggregation has been completed the aggregated results (table rows) can be referenced e.g. by adding a column of mathematical operation on the values contained in one column of the aggregated rows. Call for the application transaction will now result in an added column of mathematical formulas added with the values calculated with aggregated results. FIG. 3. Illustrates the process of creating a new processing instruction 300. Starting with a transaction call 310 retrieved data model is stored in computer memory 320. The data is processed according to processing instruction 330 specified in the variant resulting in a new data model 340 stored in memory and the results are displayed to the user 350. Iteratively, new processing instruction 360 can be specified on top of the results saving these instructions in new variants for future sessions 370.

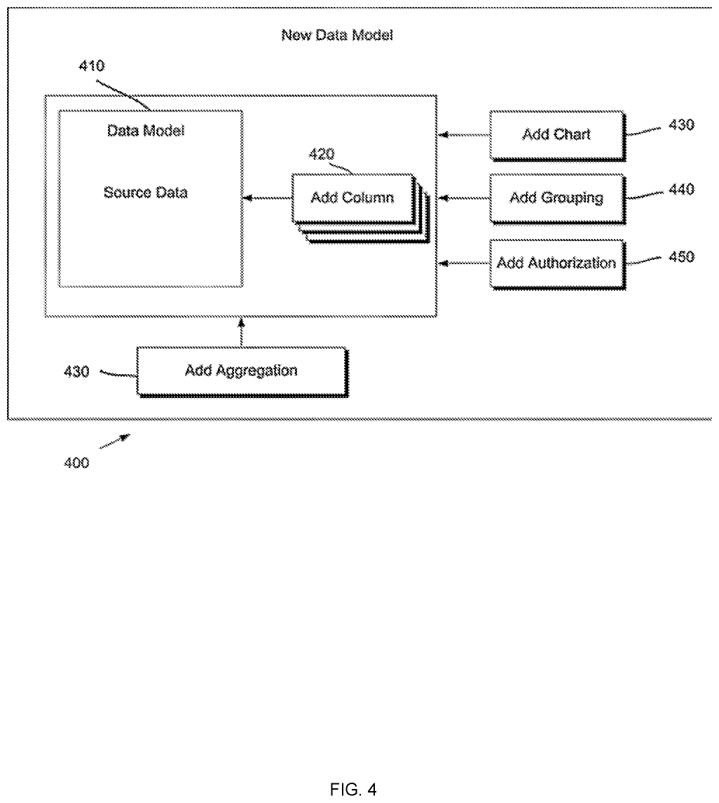

FIG. 4 is a visual portrayal of a new data model 400 created by the computer methods described above which begins with existing data model 410 retrieved form a data source. Essentially, Add Column functionalities 420 expand the data model by incorporating new data attributes created by the author, while Aggregation 430, Charts 440, Grouping 450, and Authorizations 460, can be considered functionalities to modify the expanded data model to control how the data is presented to user.

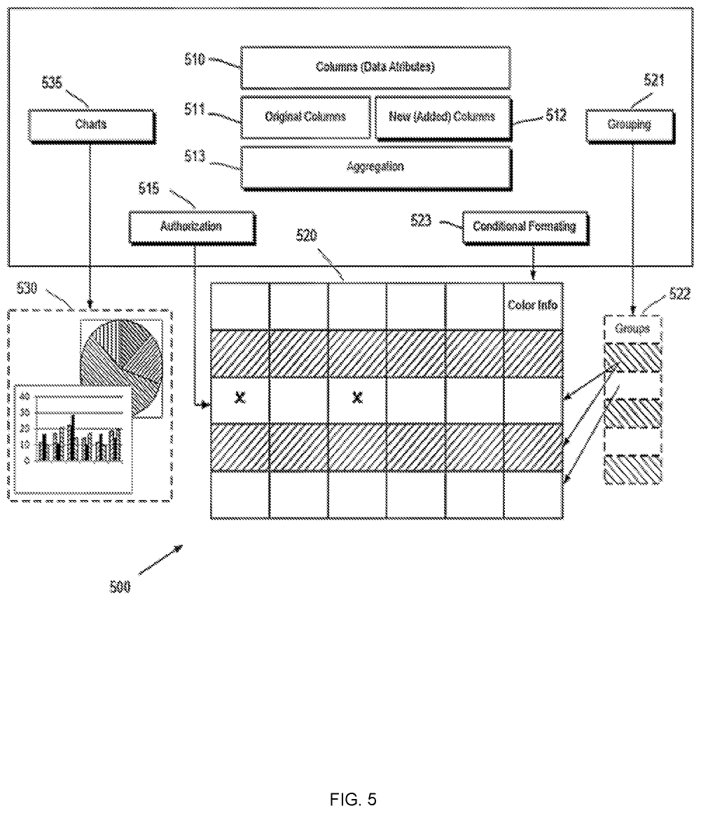

FIG. 5 is a conceptual diagram illustrating the display of data 500 in tabular format 520 or graphical format 530 by the computer methods of the present invention. Data attributes (columns) 510 are expanded by adding data attributes (Add Column functionalities) 512 to the original columns 511. Data records can be presented in separated or in aggregated layout using Aggregation functionality 513. Authorization functionality 515 further defines which data records or data attributes will be displayed to different users according to their authorization privileges. By Grouping functionality 521 the author can control the order in which data records are displayed by assigning data records into groups 522, while the Conditional Formatting 523 specifies the colors and styling formats to apply to the displayed cells. Finally, the data can be displayed in graphical format 515 invoking the Chart functionality 530. It will be appreciated that customized presentation of data was defined without programming efforts; all SAP transactions used to retrieve the data model, or enterprise reports are executed without repair.

There may be provided a computer-implemented method and a software for handling SAP platform tasks, wherein the computer implemented method and software may be configured to execute SAP ABAP reports based on ABAP list viewer (ALV) reports suppressing UI interaction (“dark” mode), wherein results of data retrieval and associated metadata (“data model”) retrieved by executing SAP ALV report, or data model retrieved from DB Table, DB View, Core Data Services (CDS), ODATA service are stored in computer memory; wherein the computer method and software further embody data processing tools for processing and enhancing said data model by forming a new data model persisting in computer memory; wherein processing and enhancing instruction are defined without programming efforts ready to run in live-environment

The processing functionalities may include adding new data attributes (“columns”) to the data model.

The new data attributes may include text labels descriptive of data values.

The new data attributes may include values retrieved from system's database by a data-retrieval process according to values defined in data model, or/and system fields values or/and constant values.

The new data attributes may include logical statements over values of specified data attributes in data model including mathematical formulas, string manipulations, dates/time calculations, values conversion, and special functions or expressions developed by the enterprise.

The new data attributes may include aggregated values from other data attributes grouped by a second set of data attributes.

The processing tools may include aggregating of data model records; wherein the result of said aggregation process are data records clustered according to set of attributes of said data records, wherein all data records corresponding to the same data attributes are merged into one record, and wherein the values of attributes are formed by aggregating values of said data records.

The processing may include assigning data records into hierarchical groups according to specified criteria over values in the data model, wherein data records are associated with a group or multiplicity of groups.

A data record, or multiplicity of data records identified by a combination of data attributes specific to said data record, wherein a specific data record can be uniquely referenced by said internal identifying key and wherein further processing instructions can be applied to specific data records.

The processing instructions may include adding new data attribute (column) of user input entries supplementary to specific data records keyed according to claim and adding optional content of metadata associated with said users input entries; wherein said user input entries can be entries of multiple users arranged in chronological order said user(s) input entries are stored in computer database

The processing instructions may include applying styling to specific records keyed according to claim; wherein styling attributes are stored in database.

The processing functionality may include applying styling to specific data records or data attributes in data model matching specified criteria.

The software may be configured to display the data model persisting in a computer memory to the user.

The data may be displayed in tabular ALV-based tabular format.

The data may be displayed in SAPUI5 application.

The software may be configured to export the data model processed by the software to a computer file wherein the format may be HTML, PDF, XML, Microsoft Excel formats (XLS, XLSX), and text formats.

The software may be configured to distribute the exported files by file transfer, e-mails, FTP, SMS, and mobile messenger applications.

The SAP report may be called in foreground or background, wherein the data model persisting in computer memory may be stored in database table (“Snapshot Table”), wherein calling of SAP report can be one time execution or scheduled according to specified timetable.

The data model can be retrieved from database and displayed in ALV.

The data model can be retrieved from database and serve as data model as an alternative to data retrieved by calling SAP.

The new data attributes may include values retrieved from snapshot table by a data-retrieval process according to values defined in data model, or/and system fields values or/and constant values.

The processing tools may include mapping of data records against SAP Authorizations Objects, performing Authorization privileges check for end-user, restricting data records to data records that comply with Authorization privileges to the end-user.

The data attributes may be assigned to Authorization, performing Authorization privileges check for end-user, restricting data attributes to data attributes that comply with Authorization privileges of the end user.

The method may include adding Business Logic stand-alone computer routines (API), assigning said computer routines to persisting data model wherein the end-user can execute said routines over selected data records in persisting data model.

The method may include adding Charts to display data contained in data model in graphical chart formats.

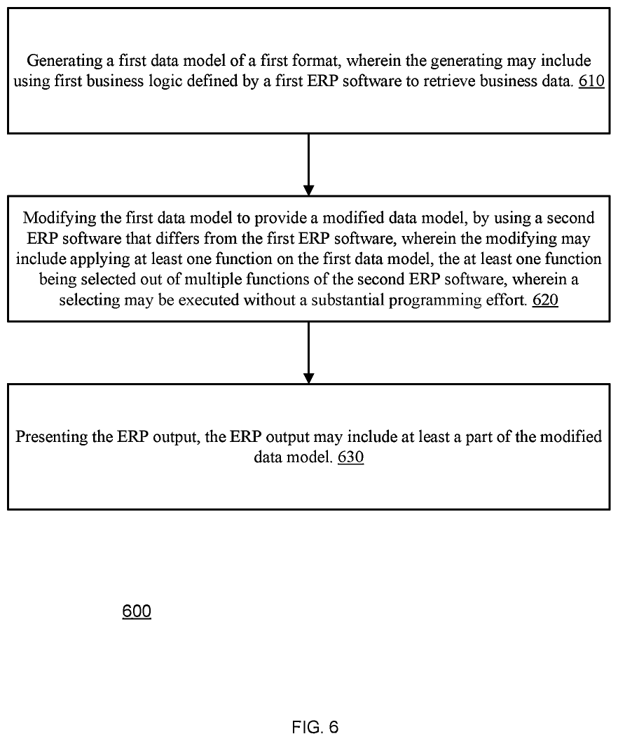

FIG. 6 illustrates an example of method 600.

Method 600 may include any step or any combination of steps previously illustrated in the application.

Method 600 may start by step 610 of generating a first data model of a first format, wherein the generating may include using first business logic defined by a first ERP software to retrieve business data.

The first ERP software may be an SAP compliant software.

Step 610 may include executing one or more Advanced Business Application Programming (ABAP) program.

Step 610 may include executing one or more first programs that may be stored in a database that also stores the business data.

Step 610 may include retrieving the business data from a database.

Method 600 may include preventing from displaying the first data model.

Step 610 may include retrieving the business data from a database that stores snapshots of business data.

Step 610 may be followed by step 620 of modifying the first data model to provide a modified data model, by using a second ERP software that differs from the first ERP software, wherein the modifying may include applying at least one function on the first data model, the at least one function being selected out of multiple functions of the second ERP software, wherein a selecting may be executed without a substantial programming effort.

Method 600 allows to use an environment in which multiple functions were defined. A user may be required to select the one or more applicable function to be applied during step 630—thereby dramatically simplifying the tailoring of the modified data model.

The functions can be updated over time.

The provision of the multiple applications at a second ERP software obliviates the need to rely on programmers of the first ERP solution.

The multiple functions of the second ERP software may be stored in the database.

Step 620 may include adding one or more added fields to the first data model to provide the modified data structure.

The one or more added fields may include text fields.

The one or more added fields may include results of calculations related to one or more fields of the first data model.

The calculations may include at least one out of mathematical calculations, string manipulations, time calculations, and values conversion.

The one or more added fields may include results of calculations related to one or more fields outside the first data model.

An added field may include a result of at least one calculation related to one or more other added fields.

The one or more added fields may include aggregated values.

Step 620 may include assigning data fields of the first data model into hierarchical groups.

Step 620 may include associating identifying keys with one or more fields of the modified data model.

Step 620 may include adding user inputs to the first data model.

Step 620 may include setting at least one of a styling and a color of at least one field of the updated data model.

Step 620 may include selectively setting at least one of a styling and a color of at least one field of the updated data model that fulfils a certain criteria.

The modified data model may be of a second format that differs from the first format.

Step 620 may include adding business logic stand-alone computer routines that may be executable by an end user, and associating the business logic stand-alone computer routines to the updated data model.

Step 620 may include generating triggers for triggering the generation of one or more charts that reflect one or more fields of the modified data model.

Step 620 may be followed by step 630 of presenting the ERP output, the ERP output may include at least a part of the modified data model.

Step 630 may include displaying the modified data model in an Advanced Business Application Programming list viewer (ALV) tabular format.

Step 630 may include displaying the modified data model using a SAPU 5 application.

Method 600 may include applying access control to at least one of the first data model and the updated data model.

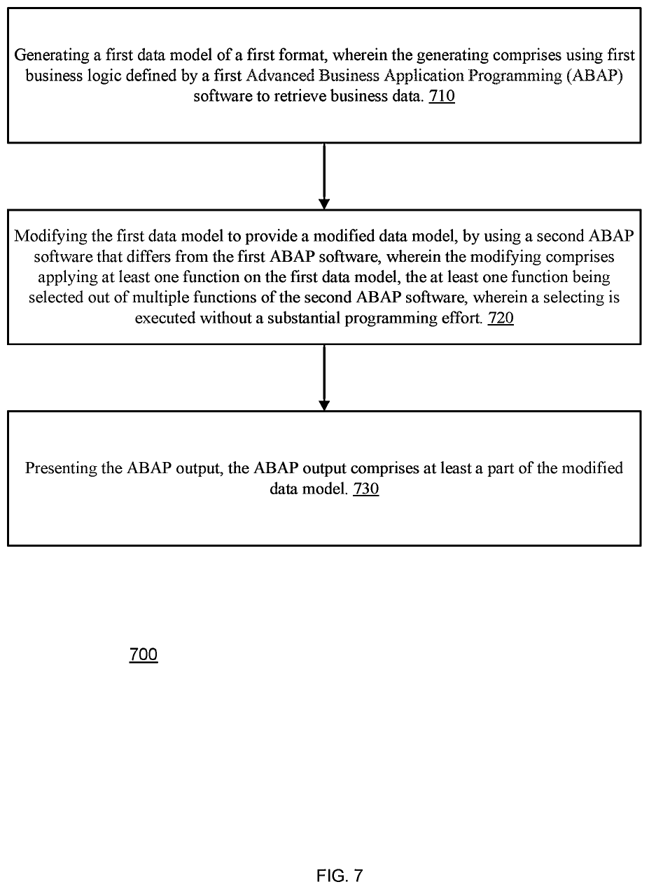

FIG. 7 illustrates an example of method 700.

Method 700 May Include the Following Steps:

Step 710 generating a first data model of a first format, wherein the generating comprises using first business logic defined by a first Advanced Business Application Programming (ABAP) software to retrieve business data.

Step 720 of modifying the first data model to provide a modified data model, by using a second ABAP software that differs from the first ABAP software, wherein the modifying comprises applying at least one function on the first data model, the at least one function being selected out of multiple functions of the second ABAP software, wherein a selecting is executed without a substantial programming effort.

Step 730 of presenting the ABAP output, the ABAP output comprises at least a part of the modified data model.

Method 600 and method 700 may include any step claimed in any of the method claims of this application.

Although some exemplary embodiments of present invention and their advantages have been described above in detail, it should be understood that various changes, substitutions and alterations can be made herein without departing from the spirit and scope of the invention as defined by the appended claims. Moreover, the scope of the present invention is not intended to be limited to the particular embodiments of the process, machine, manufacture, means, methods and steps depicted herein. Accordingly, the appended claims are intended to include within their scope such processes, machines, manufacture, means, methods, or steps.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

1. A method for presenting an enterprise resource planning (ERP) output, the method comprises:
generating a first data model of a first format, wherein the generating comprises using first business logic defined by a first ERP software to retrieve business data;
modifying the first data model to provide a modified data model, by using a second ERP software that differs from the first ERP software, wherein the modifying comprises applying at least one function on the first data model, the at least one function being selected out of multiple functions of the second ERP software, wherein a selecting is executed without a substantial programming effort; and
presenting the ERP output, the ERP output comprises at least a part of the modified data model.

2. The method according to claim 1 comprising retrieving the business data from a database.

3. The method according to claim 1 comprising preventing from displaying the first data model.

4. The method according to claim 1 wherein the first ERP software is an SAP compliant software.

5. The method according to claim 1 wherein the generating of the first data model comprises executing one or more Advanced Business Application Programming (ABAP) program.

6. The method according to claim 1 wherein the generating of the first data model comprises executing one or more first programs that are stored in a database that also stores the business data.

7. The method according to claim 6 wherein the generating of the first data model comprises executing one or more Advanced Business Application Programming (ABAP) program and wherein the multiple functions of the second ERP software are stored in the database.

8. The method according to claim 1 wherein the modifying comprises adding one or more added fields to the first data model to provide the modified data structure.

9. The method according to claim 8 wherein the one or more added fields comprises text label fields descriptive of data values.

10. The method according to claim 8 wherein the one or more added fields comprises results of manipulation related to one or more fields of the first data model.

11. The method according to claim 8 wherein the manipulation comprises at least one out of mathematical calculations, string manipulations, time calculations, and values conversion.

12. The method according to claim 8 wherein the one or more added fields comprises aggregated values of data attributes.

13. The method according to claim 1 wherein the modifying comprising aggregation of data record of the modified data model

14. The method according to claim 1 wherein the modifying comprises assigning data fields of the modified data model into hierarchical groups.

15. The method according to claim 1 wherein the modifying comprises associating identifying keys with one or more fields of the modified data model.

16. The method according to claim 1 wherein the modifying comprises adding user inputs to the modified data model.

17. The method according to claim 1 wherein the modifying comprises setting at least one of a styling and a color of at least one field of the modified data model.

18. The method according to claim 1 wherein the modifying comprises selectively setting at least one of a styling and a color of at least one field of the modified data model that fulfils a certain criteria.

19. The method according to claim 1 comprising displaying the modified data model in an Advanced Business Application Programming list viewer (ALV) tabular format.

20. The method according to claim 1 comprising displaying the modified data model using a SAPUI5 application.

21. The method according to claim 1 wherein the modified data model is of a second format that differs from the first format.

22. The method according to claim 1 wherein the modified data model is stored in a snapshot table

23. The method according to claim 1 comprising retrieving the business data from a database that stores snapshots of business data.

24. The method according to claim 1, comprising generating the snapshots of the business data

25. The method according to claim 1 comprising applying access control to at least one of the modified data model.

26. The method according to claim 1 comprising adding business logic stand-alone computer routines that are executable by an end user, and associating the business logic stand-alone computer routines to the modified data model.

27. The method according to claim 1 wherein the modifying comprises generating one or more charts that reflect one or more fields of the modified data model.

28. The method according to claim 1 wherein the method comprises retrieving the business data from a database; wherein the modifying comprises adding one or more added fields to the first data model to provide the modified data structure; wherein the new added fields comprise values retrieved from the database by a data-retrieval process according to at least one out of (a) values defined in the first data model, (b) system fields values, and (c) constant values.

29. The method according to claim 1 wherein the method comprises retrieving the business data from a database; wherein the modifying comprises adding one or more added fields to the first data model to provide the modified data structure; wherein the new added fields comprise values retrieved from a snapshot table by a data-retrieval process according to at least one out of (a) values defined in the first data model, (b) system fields values, and (c) constant values.

30. The method according to claim 1 comprising exporting the modified data model to provide an exported modified data model that has a format selected out of HTML, PDF, XML, Microsoft Excel formats (XLS, XLSX), and text formats.

31. The method according to claim 32 comprising distributing the exported modified data model by at least one of a file transfer, electronic mail, FTP, SMS, and a mobile messenger application.

32. A method for presenting business data, the method comprises:
generating a first data model of a first format, wherein the generating comprises using first business logic defined by a first Advanced Business Application Programming (ABAP) software to retrieve business data;
modifying the first data model to provide a modified data model, by using a second ABAP software that differs from the first ABAP software, wherein the modifying comprises applying at least one function on the first data model, the at least one function being selected out of multiple functions of the second ABAP software, wherein a selecting is executed without a substantial programming effort; and
presenting the ABAP output, the ABAP output comprises at least a part of the modified data model.

33. The method according to claim 32 comprising retrieving the business data from a database.

34. The method according to claim 32 comprising preventing from displaying the first data model.

35. The method according to claim 32 wherein the generating of the first data model comprises executing one or more first programs that are stored in a database that also stores the business data.

36. The method according to claim 32 wherein the modifying comprises adding one or more added fields to the first data model to provide the modified data structure.

37. The method according to claim 36 wherein the one or more added fields comprises text label fields descriptive of data values.

38. The method according to claim 36 wherein the one or more added fields comprises results of manipulation related to one or more fields of the first data model.

39. The method according to claim 36 wherein the manipulation comprises at least one out of mathematical calculations, string manipulations, time calculations, and values conversion.

40. The method according to claim 36 wherein the one or more added fields comprises aggregated values of data attributes.

41. The method according to claim 32 wherein the modifying comprising aggregation of data record of the modified data model

42. The method according to claim 32 wherein the modifying comprises assigning data fields of the modified data model into hierarchical groups.

43. The method according to claim 32 wherein the modifying comprises associating identifying keys with one or more fields of the modified data model.

44. The method according to claim 32 wherein the modifying comprises adding user inputs to the modified data model.

45. The method according to claim 32 wherein the modifying comprises setting at least one of a styling and a color of at least one field of the modified data model.

46. The method according to claim 32 wherein the modifying comprises selectively setting at least one of a styling and a color of at least one field of the modified data model that fulfils a certain criteria.

47. The method according to claim 32 comprising displaying the modified data model in an Advanced Business Application Programming list viewer (ALV) tabular format.

48. The method according to claim 32 comprising displaying the modified data model using a SAPUI5 application.

49. The method according to claim 32 wherein the modified data model is of a second format that differs from the first format.

50. The method according to claim 32 wherein the modified data model is stored in a snapshot table

51. The method according to claim 32 comprising retrieving the business data from a database that stores snapshots of business data.

52. The method according to claim 32, comprising generating the snapshots of the business data

53. The method according to claim 32 comprising applying access control to at least one of the modified data model.

54. The method according to claim 32 comprising adding business logic stand-alone computer routines that are executable by an end user, and associating the business logic stand-alone computer routines to the modified data model.

55. The method according to claim 32 wherein the modifying comprises generating one or more charts that reflect one or more fields of the modified data model.

56. The method according to claim 32 wherein the method comprises retrieving the business data from a database; wherein the modifying comprises adding one or more added fields to the first data model to provide the modified data structure; wherein the new added fields comprise values retrieved from the database by a data-retrieval process according to at least one out of (a) values defined in the first data model, (b) system fields values, and (c) constant values.

57. The method according to claim 32 wherein the method comprises retrieving the business data from a database; wherein the modifying comprises adding one or more added fields to the first data model to provide the modified data structure; wherein the new added fields comprise values retrieved from a snapshot table by a data-retrieval process according to at least one out of (a) values defined in the first data model, (b) system fields values, and (c) constant values.

58. The method according to claim 32 comprising exporting the modified data model to provide an exported modified data model that has a format selected out of HTML, PDF, XML, Microsoft Excel formats (XLS, XLSX), and text formats.

59. The method according to claim 32 comprising distributing the exported modified data model by at least one of a file transfer, electronic mail, FTP, SMS, and a mobile messenger application.

60. A method for presenting business data, the method comprises:
generating a first data model of a first format, wherein the generating comprises using first business logic defined by a first business software to retrieve business data;
modifying the first data model to provide a modified data model, by using a second business software that differs from the first business software, wherein the modifying comprises applying at least one function on the first data model, the at least one function being selected out of multiple functions of the second business software, wherein a selecting is executed without a substantial programming effort; and
presenting the business output, the business output comprises at least a part of the modified data model;
wherein each one of the first and second business software is at least one out of an enterprise resource planning (ERP) software and an Advanced Business Application Programming (ABAP) software.

61. A non-transitory computer readable medium for presenting an enterprise resource planning (ERP) output, the non-transitory computer readable medium stores instructions for:
generating a first data model of a first format, wherein the generating comprises using first business logic defined by a first ERP software to retrieve business data;
modifying the first data model to provide a modified data model, by using a second ERP software that differs from the first ERP software, wherein the modifying comprises applying at least one function on the first data model, the at least one function being selected out of multiple functions of the second ERP software, wherein a selecting is executed without a substantial programming effort; and presenting the ERP output, the ERP output comprises at least a part of the modified data model.

62. A non-transitory computer readable medium for presenting business data, the non-transitory computer readable medium stores instructions for:
generating a first data model of a first format, wherein the generating comprises using first business logic defined by a first Advanced Business Application Programming (ABAP) software to retrieve business data;
modifying the first data model to provide a modified data model, by using a second ABAP software that differs from the first ABAP software, wherein the modifying comprises applying at least one function on the first data model, the at least one function being selected out of multiple functions of the second ABAP software, wherein a selecting is executed without a substantial programming effort; and
presenting the ABAP output, the ABAP output comprises at least a part of the modified data model.

63. A computerized system for presenting an enterprise resource planning (ERP) output, the computerized system is configured to execute the steps of:
generating a first data model of a first format, wherein the generating comprises using first business logic defined by a first ERP software to retrieve business data;
modifying the first data model to provide a modified data model, by using a second ERP software that differs from the first ERP software, wherein the modifying comprises applying at least one function on the first data model, the at least one function being selected out of multiple functions of the second ERP software, wherein a selecting is executed without a substantial programming effort; and presenting the ERP output, the ERP output comprises at least a part of the modified data model.

64. A computerized system for presenting business data, the computerized system is configured to execute the steps of:
generating a first data model of a first format, wherein the generating comprises using first business logic defined by a first Advanced Business Application Programming (ABAP) software to retrieve business data;
modifying the first data model to provide a modified data model, by using a second ABAP software that differs from the first ABAP software, wherein the modifying comprises applying at least one function on the first data model, the at least one function being selected out of multiple functions of the second ABAP software, wherein a selecting is executed without a substantial programming effort; and
presenting the ABAP output, the ABAP output comprises at least a part of the modified data model.
